(19) United States
(12) Patent Application Publication
(10) Pub. No.: US 2010/0264726 A1
(43) Pub. Date: Oct. 21, 2010

(54) FUELL CONSUMPTION REDUCTION DEVICE

(75) Inventor: Pisit Dechwanapong, Bangkok (TH)

Correspondence Address: SOROKER-AGMON ADVOCATE AND PATENT ATTORNEYS, NOLTON HOUSE, 14 SHENKAR STREET, HERZELIYA PITUACH, 46725, IL

(73) Assignees: Tzvika Hershko, Bangkok (TH); Assaf Tvoua, Bangkok (TH)

(21) Appl. No.: 12/426,294

(22) Filed: Apr. 20, 2009

(51) Int. Cl. B60L 1/00

(52) U.S. Cl. 307/9.1

(57) ABSTRACT

A fuel consumption reduction device for deployment in a vehicle, including:

an electronic circuit, an encasement adapted to fit into the cigarette lighter socket of the vehicle and to enclose the electronic circuit, a positive terminal positioned on one end of the encasement that is adapted to form contact between the electronic circuit and the positive voltage source connection of the vehicle located in the cigarette lighter socket, at least one negative terminal positioned on the side of the encasement that is adapted to form contact between the electrical circuit and the negative voltage connection of the cigarette lighter; and wherein the electronic circuit is adapted to reduce noise and stabilize the voltage signal of the vehicle.

### FIELD OF THE INVENTION

The present Invention relates generally to a device for reducing the consumption of fuel by motorized vehicles and more specifically to reducing fuel consumption through the use of an electrical circuit.

### BACKGROUND OF THE INVENTION

Fuel consumption is a key expense in the use of motorized vehicles. Motorized vehicles burn fuel of various types, for example gasoline, liquefied petroleum gas (LPG), bio-diesel or diesel. However regardless of the type of fuel used it remains a key expense in the usage of the vehicle.

Many fuel economy boosting technologies have been suggested, for example using lighter materials for the vehicle, using thinner engine oils that require less energy to circulate, using better coolants so that engines reach their efficient operating temperature quicker, using low rolling resistance tires or optimizing engine combustion strategies.

Typically vehicles use 12 or 24 Volt batteries for providing electric current to operate the vehicle. An alternator with a voltage regulator charges the battery while the engine is working and serves as a backup voltage source. The electrical system provides power for lights (e.g. headlights), fans, defrosters, speakers, radios and many other systems in the vehicle. In modern vehicles an electrical control unit (ECU) is used to control provision of fuel to the engine. The ECU typically controls some or all of the following functions and other functions, in the engine:

1. Engine speed;

2. Engine fuel pump control;

3. Engine temperature control;

4. Engine timing control.

The ECU typically includes a logic circuit or computer to accept sensor readings and optimally control functionality of the engine during the motion of the vehicle. Generally each vehicle manufacturer programs the ECU to provide optimum performance and optimal fuel consumption. The ECU is designed to function at a specific voltage, however in the real world during use of the vehicle the electrical currents in the vehicle are situated in many different states and affected by interferences, for example working with the lights off or with the lights on, working with the radio off or on, working with heaters/coolers and fans off or on, poor (e.g. corroded) contacts and strong contacts, and many other situations. As a result the electrical currents in the vehicle are not a perfect regulated voltage DC signal but rather a noisy signal fluctuating around the specific voltage. The noisy signal has a detrimental affect on the accuracy of the functionality of the ECU, thus preventing fuel consumption from reaching its optimal state.

### SUMMARY OF THE INVENTION

An aspect of an embodiment of the invention, relates to a fuel consumption reducer that includes an electronic circuit connected in parallel to the power source of the vehicle to clean out noise from the power signal in the vehicles electric system. In an exemplary embodiment of the invention, the electric circuit absorbs excess voltages and supplements deficient voltages to achieve a more linear regulated voltage in the electric system of the vehicle. In an exemplary embodiment of the invention, the fuel consumption reducer is plugged into the cigarette lighter of the vehicle. Alternatively, the fuel consumption reducer is connected in other positions in parallel to the battery of the vehicle, for example connected directly to the battery or through the fuse box.

In an exemplary embodiment of the invention, the fuel consumption reducer provides an indication regarding the charge status of the battery of the vehicle. Optionally, if the charge status of the vehicle falls below a predefined threshold value the fuel consumption reducer will provide an indication, so that the user of the vehicle will be aware of the need to service the vehicle, for example to change the battery.

In some embodiments of the invention, the fuel consumption reducer provides a visual alarm or an audible alarm regarding the charge status. Optionally, a panel with visual indication is tilted upward so that it is easily viewable by the vehicle user.

There is thus provided in accordance to an exemplary embodiment of the invention, a fuel consumption reduction device for deployment in a vehicle, comprising:

an electronic circuit;

an encasement adapted to fit into the cigarette lighter socket of the vehicle and to enclose the electronic circuit;

a positive terminal positioned on one end of the encasement that is adapted to form contact between the electronic circuit and the positive voltage source connection of the vehicle located in the cigarette lighter socket;

at least one negative terminal positioned on the side of the encasement that is adapted to form contact between the electrical circuit and the negative voltage connection of the cigarette lighter; and

wherein the electronic circuit is adapted to reduce noise and stabilize the voltage signal of the vehicle.

In an exemplary embodiment of the invention, the electronic circuit is adapted to reduce noise and stabilize the voltage signal of the vehicle by absorbing excess voltage from the voltage signal of the vehicle and supplementing deficient voltage of the voltage signal. Optionally, the device further comprises a front panel that provides an indication if the device is functional. In an exemplary embodiment of the invention, the indication is provided by a LED that is a part of the electronic circuit. Optionally, the electronic circuit is adapted to provide an indication if the status of the battery of the vehicle is below a pre-selected value. In an exemplary embodiment of the invention, the pre-selected value is user selectable. Optionally, the device further comprises a switch to turn the device on or off during use of the vehicle.

There is further provided according to an exemplary embodiment of the invention, a method of fuel consumption reduction in a vehicle, comprising;

preparing an electronic circuit that is adapted to reduce noise and stabilize the voltage signal provided by the battery of a vehicle connected in parallel to the electronic circuit;

enclosing the electronic circuit in a body that is adapted to fit into the cigarette lighter socket of the vehicle and form electrical contact between the electronic circuit and the electrical system of the vehicle in parallel to the battery;

plugging the body into the cigarette lighter socket of the vehicle, so that it can be activated during the use of the vehicle. Optionally, the electronic circuit is automatically activated when starting the vehicle.

In an exemplary embodiment of the invention, the electronic circuit can be selectively turned on and turned off by the user of the vehicle when deployed in the cigarette lighter socket of the vehicle.

### BRIEF DESCRIPTION OF THE DRAWINGS

The present invention will be understood and better appreciated from the following detailed description taken in conjunction with the drawings. Identical structures, elements or parts, which appear in more than one figure, are generally labeled with the same or similar number in all the figures in which they appear, wherein:

FIG. 1 is a schematic illustration of an electrical circuit of a vehicle for deploying a fuel consumption reducer, according to an exemplary embodiment of the invention;

FIG. 2A is a schematic illustration of a top view of a fuel consumption reducer, according to an exemplary embodiment of the invention;

FIG. 2B is a schematic illustration of a side view of a fuel consumption reducer, according to an exemplary embodiment of the invention:

FIG. 3A is a schematic graph of the voltage signal of a vehicle before deploying a fuel consumption reducer, according to an exemplary embodiment of the invention;

FIG. 3B is a schematic graph of the voltage signal of a vehicle after deploying a fuel consumption reducer, according to an exemplary embodiment of the invention;

FIG. 4A is a diagram of a circuit for smoothing the power signal of a vehicle, according to an exemplary embodiment of the invention; and

FIG. 4B is a diagram of a circuit for determining the status of the vehicle battery, according to an exemplary embodiment of the invention.

### DETAILED DESCRIPTION

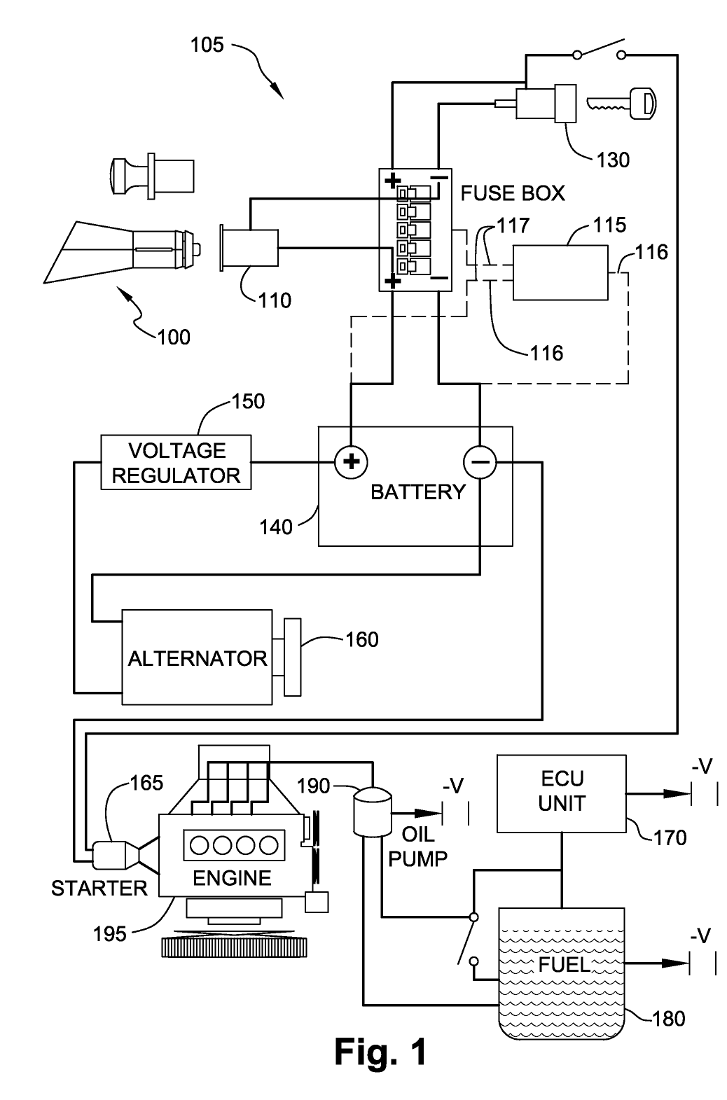

FIG. 1 is a schematic illustration of an electrical circuit 105 of a vehicle for deploying a fuel consumption reducer 100, according to an exemplary embodiment of the invention. In an exemplary embodiment of the invention, fuel consumption reducer 100 is Inserted into a cigarette lighter socket 110 of the vehicle. The cigarette lighter socket 110 is connected via a fuse box 120 to a battery 140 that serves as the basic power source of the vehicle. During use of the vehicle, the power from battery 140 is supplemented with power from an alternator 160, which provides power through a voltage regulator 150. Alternator 160 additionally charges battery 140.

A switch 130 provides power to a starter 165 to start engine 195 of the vehicle. Once engine 195 is started an electrical control unit (ECU) 170 controls an oil pump 190 and fuel pump 180, to provide the correct amount of fuel and oil to engine 195 while the vehicle is being used.

In an exemplary embodiment of the invention, during use of the vehicle, fuel consumption reducer 100 is connected in parallel to battery 140 and it smoothes out the power signal provided by the battery to the various electrical devices in the vehicle including ECU 170.

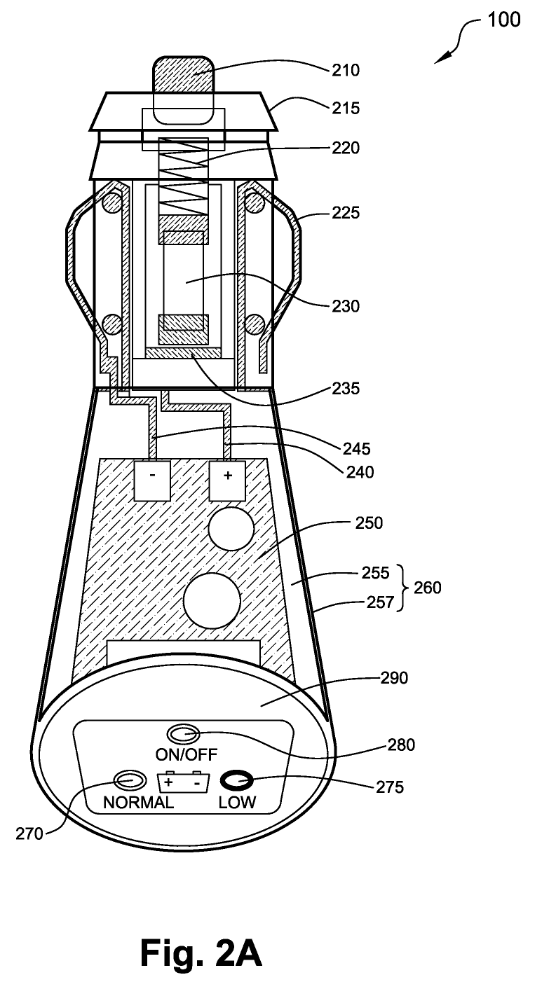

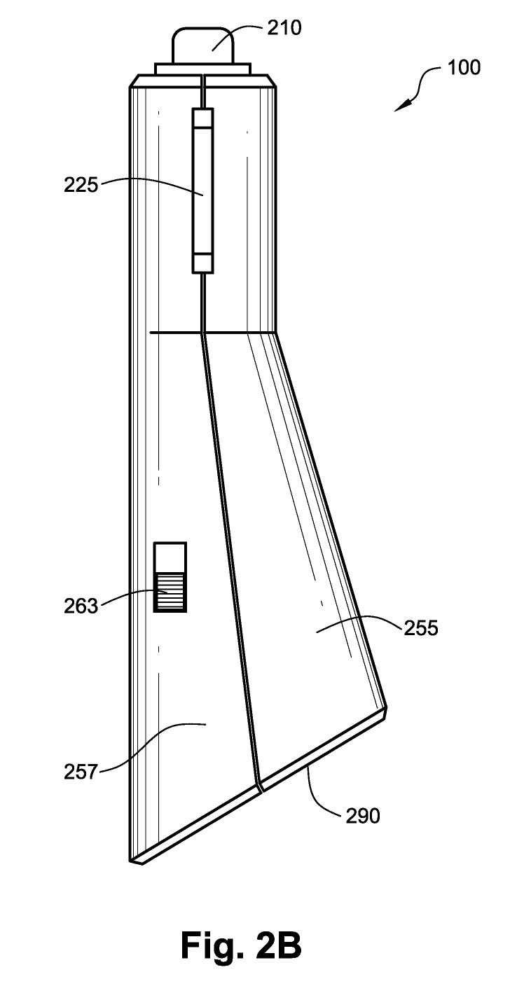

FIG. 2A is a schematic illustration of a top view of fuel consumption reducer 100, according to an exemplary embodiment of the invention. In an exemplary embodiment of the invention, fuel consumption reducer 100 includes an essentially conical shaped body 260 that is made up from an upper part 255 and a lower part 257, which are connected together to encase the internal parts of fuel consumption reducer 100. Optionally, a front panel 290 is placed at the fore end of fuel consumption reducer 100 facing the vehicle user to provide indications regarding the status of fuel consumption reducer 100. The rear end that is plugged into cigarette lighter socket 110 of the vehicle includes a positive terminal 210 positioned in a plug in cover 215, to be able to open and close the rear end of fuel consumption reducer 100, for example to change a fuse 230. Positive terminal 210 connects to a spring 220 that is in contact with fuse 230. Fuse 230 is in contact with a base plug terminal 235, which is connected via a wired positive line 240 to a circuit 250, which provides the functionality of fuel consumption reducer 100. Circuit 250 is also connected through a wired negative line 245 to negative terminals 225, which connect to the negative contacts of cigarette lighter socket 110. Optionally, the above described structure for fuel consumption reducer 100 may vary and other structures may be used to implement a device containing an electrical circuit 250 placed in parallel to other devices in the vehicle such as ECU unit 170.

Deploying fuel consumption reducer 100 in cigarette lighter socket 110 makes it easy to deploy and enables it to be in view of the users of the vehicle. However in some embodiments of the invention, fuel consumption reducer 100 may be installed as a permanent device 115 in the vehicle as shown in FIG. 1, for example like a radio or alarm. The device may be positioned inside the vehicle in view of the users or in any other position, for example under the hood. Optionally, permanent device 115 is connected directly (116) to the battery 140 or connected (117) through fuse box 120.

In some embodiments of the invention, electrical circuit 250 additionally provides an indication regarding the status of the charge in battery 140, for example if battery 140 is in a normal state or if the charge is low and the battery needs to be serviced. In an exemplary embodiment of the invention, front panel 290 includes LEDs to provide indication regarding the status of fuel consumption reducer 100. Optionally, A first LED 280 many indicate if the device is on or off. A second LED 270 may indicate if the status of charge in battery 140 is normal. A third LED may indicate if the status of charge in battery 140 is low, for example when the voltage is below 11.5V for a car or 23V for a larger vehicle such as a truck. Optionally, a single LED may be able to display more than one color (e.g. green and red): one color may indicate that the charge is below 11.5V and another color may indicate that the charge is below 23V. Alternatively, additional LEDs may be used, to provide various indications. In some embodiments of the invention, other types of indicators may be used, for example an LCD screen or a 7 segment display.

In some embodiments of the invention, front panel 290 may also include an activation switch, for example by pressing on LED 280, to turn fuel consumption reducer 100 on or off during use of the vehicle. In some embodiments of the invention, fuel consumption reducer 100 turns on automatically when the vehicle switch 130 is turned to the on position or when the vehicle motor is turned on. Optionally, LED 280 will light up, for example with a green light to indicate that fuel consumption reducer 100 is active.

In some embodiments of the invention, fuel consumption reducer 100 provides indication of the status of battery 140 when the vehicle is not turned on. Alternatively or additionally, fuel consumption reducer 100 provides indication of the status of battery 140 after turning on the switch but before starting the motor of the vehicle. In some vehicles the cigarette lighter socket 110 is only provided power after turning on switch 130, so if fuel consumption reducer 100 is connected via cigarette lighter socket 110 it will only provide indication for those vehicles after turning on the switch.

FIG. 2B is a schematic illustration of a side view of fuel consumption reducer 100, according to an exemplary embodiment of the invention. In an exemplary embodiment of the invention, upper part 255 is not symmetrical with lower part 257 in forming body 260. Optionally, upper part 255 is shorter so that front panel 290 will be tilted upward to allow easy visibility of front panel 290 by the vehicle driver.

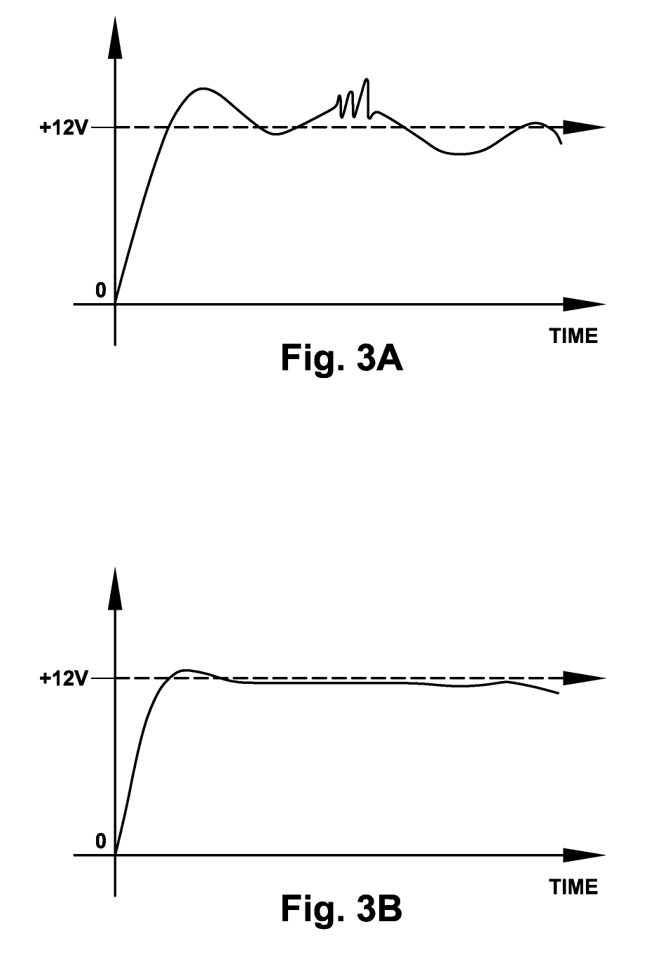

FIG. 3A is a schematic graph of the voltage signal of a vehicle before deploying fuel consumption reducer 100, according to an exemplary embodiment of the invention. FIG. 3B is a schematic graph of the voltage signal of a vehicle after deploying fuel consumption reducer 100, according to an exemplary embodiment of the invention. In standard vehicles the voltage signal suffers from noise due to the electronic equipment powered by the electrical system of the vehicle and optionally also resulting from the effects caused by the contribution of alternator 160. In an exemplary embodiment of the invention, fuel consumption reducer 100 reduces the electrical noise and stabilizes the voltage, so that after deploying fuel consumption reducer 100, ECU 170 is provided with a cleaner and more accurate voltage signal. As a result ECU 170 functions more accurately and reduces fuel consumption of the vehicle.

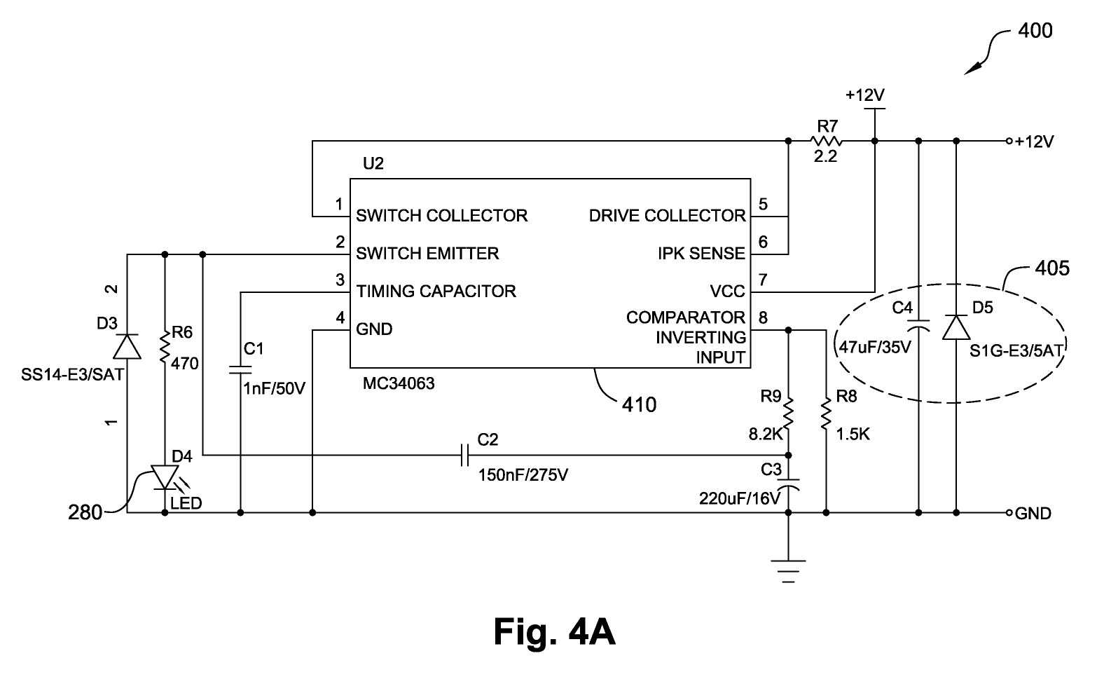

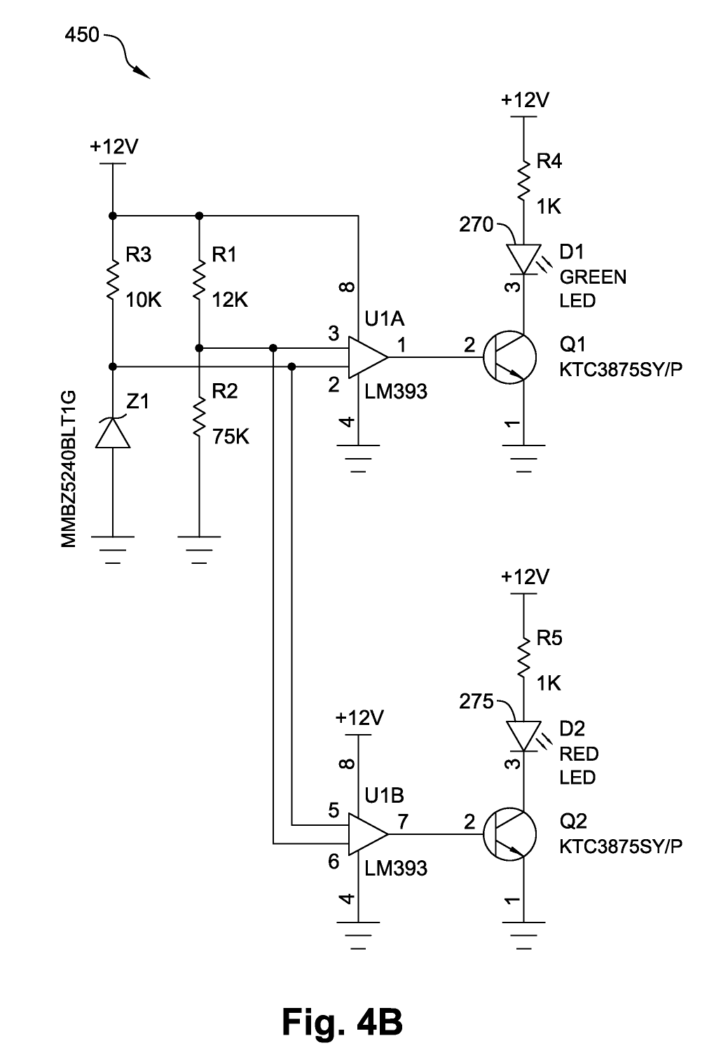

FIG. 4A is a diagram of a circuit 400 for smoothing the voltage signal of a vehicle, according to an exemplary embodiment of the invention. In an exemplary embodiment of the invention, circuit 400 serves as a voltage regulator for the voltage in the vehicle. Circuit 400 uses a capacitor diode setup 405 to store excess electrical power and supplement voltage deficiencies of the voltage signal of the vehicle. The circuit includes a DC-DC converter control circuit 410 (e.g. MC34063) to control the functionality of circuit 400 and provide a smoother stabilized voltage signal in the electrical circuits of the vehicle. Optionally, the circuit includes LED 280 to provide indication that fuel consumption reducer 100 is functional.

FIG. 4B is a diagram of a circuit 450 for determining the status of the vehicle battery, according to an exemplary embodiment of the invention. In an exemplary embodiment of the invention, circuit 450 includes a resistive voltage divider to operate LED 270 (Normal) and LED 275 (Low). Optionally, if the voltage provided by battery 140 is lower than a pre-selected threshold value (e.g. 11.5V or 23V as explained above) LED 275 (Low) will be lit up to provide a warning for the user of the vehicle to have the vehicle serviced. Alternatively, if the voltage provided by battery 140 is higher than the pre-selected voltage LED 270 (Normal) will be lit up.

In some embodiments of the invention, fuel consumption reducer 100 is provided with models with different pre-selected voltage thresholds, for example a threshold of 11.5V for cars and 23V for trucks. Alternatively, a single model may have a selectable threshold, for example that can be selected by a switch 263 (in FIG. 2B) on body 260.

In an exemplary embodiment of the invention, the user inserts fuel consumption reducer 100 into cigarette lighter socket 110 of the vehicle. The user turns switch 130 to the on position. Optionally, two green LEDs will be lit on front panel 290. One indicating that the device is receiving power and functional and the other indicating that battery 140 of the vehicle is functioning correctly.

In an exemplary embodiment of the invention, fuel consumption reducer 100 was tested on various vehicles to measure the effectiveness of the device. The vehicles tested included vehicles from the following manufacturers:

1. Toyota.

2. Honda.

3. Subaru.

4. Isuzu.

Some of the vehicles tested used gasoline and some used Diesel. The engine sizes of the vehicles tested varied from 1500 cc to 3000 cc.

The measured results showed savings in fuel consumption of between 7% to 30% depending on various factors, for example the type of vehicle (e.g. manufacturer, model), the age of the vehicle, and the electronic equipment deployed in the vehicle (some equipment cause more electrical noise than others).

An exemplary method that can be used for testing fuel consumption is performed by the following process:

1. Load the fuel tank until it is completely full.

2. Drive a pre-selected distance (e.g. 100, 200, 300 km/miles).

3.Refill the fuel tank until it is completely full and record the amount of fuel required for refilling the fuel tank.

4. Calculate the average fuel consumption per liter/gallon.

The above process can be performed with fuel consumption reducer 100 deployed and without it deployed to compare the results. The above process can be performed multiple times with and without deploying fuel consumption reducer 100 to factor out the effects relating to the specific course taken on each round of the testing process. Since driving through traffic may be more fuel consuming than driving on an open highway.

It should be appreciated that the above described methods and apparatus may be varied in many ways, including omitting or adding steps, changing the order of steps and the type of devices used. It should be appreciated that different features may be combined in different ways. In particular, not all the features shown above in a particular embodiment are necessary in every embodiment of the invention. Further combinations of the above features are also considered to be within the scope of some embodiments of the invention.

It will be appreciated by persons skilled in the art that the present invention is not limited to what has been particularly shown and described hereinabove. Rather the scope of the present invention is defined only by the claims, which follow.

We claim:

1. A fuel consumption reduction device for deployment in a vehicle, comprising:
an electronic circuit;
an encasement adapted to fit into the cigarette lighter socket of the vehicle and to enclose the electronic circuit;
a positive terminal positioned on one end of the encasement that is adapted to form contact between the electronic circuit and the positive voltage source connection of the vehicle located in the cigarette lighter socket;
at least one negative terminal positioned on the side of the encasement that is adapted to form contact between the electrical circuit and the negative voltage connection of the cigarette lighter; and
wherein said electronic circuit is adapted to reduce noise and stabilize the voltage signal of the vehicle.

2. A fuel consumption reduction device according to claim 1, wherein said electronic circuit is adapted to reduce noise and stabilize the voltage signal of the vehicle by absorbing excess voltage from the voltage signal of the vehicle and to supplement deficient voltage of the voltage signal.

3. A fuel consumption reduction device according to claim 1, further comprising a front panel that provides an indication if the device is functional.

4. A fuel consumption reduction device according to claim 3, wherein said indication is provided by a LED that is a part of the electronic circuit.

5. A fuel consumption reduction device according to claim 1, wherein said electronic circuit is adapted to provide an indication if the status of the battery of the vehicle is below a pre-selected value.

6. A fuel consumption reduction device according to claim 5, wherein said pre-selected value is user selectable.

7. A fuel consumption reduction device according to claim 1, further comprising a switch to turn the device on or off during use of said vehicle.

8. A method of fuel consumption reduction in a vehicle, comprising:
preparing an electronic circuit that is adapted to reduce noise and stabilize the voltage signal provided by the battery of a vehicle connected in parallel to said electronic circuit;
enclosing said electronic circuit in a body that is adapted to fit into the cigarette lighter socket of the vehicle and form electrical contact between the electronic circuit and the electrical system of the vehicle in parallel to the battery;
plugging said body into the cigarette lighter socket of the vehicle, so that it can be activated during the use of the vehicle.

9. A method of fuel consumption reduction in a vehicle according to claim 8, wherein said electronic circuit is automatically activated when starting the vehicle.

10. A method, of fuel consumption reduction in a vehicle according to claim 8, wherein said electronic circuit can be selectively turned on and turned off by the user of the vehicle when deployed in the cigarette lighter socket, of the vehicle.
